(19) United States
(12) Patent Application Publication
(10) Pub. No.: US 2025/0106264 A1
(43) Pub. Date: Mar. 27, 2025

(54) FIRST IMS NODE, SECOND IMS NODE, NETWORK NODE AND METHODS IN A COMMUNICATIONS NETWORK

(71) Applicant: Telefonaktiebolaget LM Ericsson (publ), Stockholm (SE)

(72) Inventors: Jose Miguel Dopico Sanjuan, Madrid (ES); Emiliano Merino Vazquez, Madrid (ES); David Castellanos Zamora, Madrid (ES)

(21) Appl. No.: 18/729,845

(22) PCT Filed: Aug. 26, 2022
(86) PCT No.: PCT/EP2022/073767

§ 371 Date: Jul. 17, 2024

(30) Foreign Application Priority Data
Jan. 17, 2022 (EP) 22382024.2

(51) Int. Cl. H04L 65/1073; H04L 65/1016

(52) U.S. Cl. CPC H04L 65/1073; H04L 65/1016

(57) ABSTRACT

A method performed by an a first Internet Protocol, IP, Multimedia Subsystem, IMS, node for selecting a second IMS node from one or more second IMS in a communications network is provided. The first IMS node and the one or more second IMS nodes are operating in an IMS network. Upon receiving, from a User Equipment, UE, a registration request message requesting the UE to be registered to the IMS network, the first IMS node obtains (201), from a subscriber data node, subscriber data related to the UE. The subscriber data comprises one or more capabilities associated to a second IMS node to be used in the registration procedure. The first IMS node sends (202), to a network node, a request to identify one or more second IMS nodes for the registration procedure, based on the one or more capabilities in the obtained subscriber data. The request comprises the one or more capabilities. The first IMS node receives (203) a response to the request from the network node. The response comprises selection data related to a selection of a second IMS node from one or more identified second IMS nodes. The one or more identified second IMS nodes supports at least one of the one or more capabilities comprised in the obtained subscriber data. The first IMS node selects (204) a second IMS node from the one or more identified second IMS nodes for registering the UE to the IMS network. The selecting is based on the received selection data. The first IMS node proceeds with the registration of the UE by sending (205) a message to the selected second IMS node. The message requests the selected second IMS node to register the UE to the IMS network.

### TECHNICAL FIELD

Embodiments herein relate to a first Internet Protocol (IP) Multimedia Subsystem (IMS) node, a second IMS node a network node and methods therein. In some aspects, they relate to selecting a second IMS node in an IMS network, in a communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

The Internet Protocol (IP) Multimedia Subsystem (IMS) is a well-known 3GPP standard allowing sessions to be set up between two or more parties for a broad variety of services such as voice or video call, interactive messaging sessions or third party specific applications. A protocol chosen by 3GPP is the Session Initiation Protocol (SIP). SIP provides a mechanism for the registration of UEs and for setting up multimedia sessions. The SIP REGISTER method enables the registration of user agent's current location and the INVITE method enables the setting up of a session. IMS is being implemented by Public Land Mobile Network (PLMN) operators as an architectural framework for delivering IP multimedia services to their subscribers.

### Functional Elements in the IMS Network

An IMS network comprises several network entities, some of which are discussed here.

### Proxy Call Session Control Function (P-CSCF)

The P-CSCF is the first point of contact for a UE connected to the IMS network. It may be located in either a home network or a visited network. It behaves a SIP-proxy, i.e. it accepts requests and services them internally or forwards them on and forwards SIP requests or responses to the UE.

### Serving Call Session Control Function (S-CSCF)

The S-CSCF is a SIP server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them on

### Home Subscriber Server (HSS)

The HSS is a subscriber database comprising subscriber profiles, performs authentication and authorization, and provides information on service provisioned for subscribers and information on the location and IP address of a subscriber.

### Application Server (AS)

An AS, e.g. a SIP AS, Open Service Access (OSA) AS or a Customized Applications for Mobile network Enhanced Logic (CAMEL) IP Multimedia-Service Switching Function (IM-SSF), offers value added IP Multimedia (IM) services and resides e.g. in a UEs home network or in a third party location. The third party may be a network or simply a stand-alone AS.

As described in 3GPP Technical Specification 23.228, the I-CSCF selects an S-CSCF based on the capabilities received from the HSS when trying to allocate an S-CSCF for an IMS subscriber. These capabilities are used in the I-CSCF based on local, and manual, configuration. E.g. if a given IMS subscriber needs a certain S-CSCF capability to be supported, each I-CSCF in the IMS network needs to have the capability configured and mapped to a certain S-CSCF which should satisfy the mandatory capabilities and as many of the optional capabilities as possible. In addition, if there are several S-CSCF matching the mandatory and optional capabilities, the I-CSCF has to be configured with a prioritized list of S-CSCFs, e.g. based on the locality/geographical location of the S-CSCF.

### SUMMARY

As part of developing embodiments herein a problem was identified by the inventor and will first be discussed.

The current procedures in IMS rely on a large configuration on each I-CSCF of the network. Moreover, if a new S-CSCF is deployed, all the I-CSCFs are impacted when it comes to additional configuration to be done in order to make the new S-CSCF eligible. This results in a lack of automation in the network, since there are a lot of manual interventions in the operator's network, and this is always prone to errors.

Further, the I-CSCF selects an S-CSCF based on static configuration solely based on capabilities. However, it has been proven in many real deployments that, when there e.g. is a S-CSCF software upgrade, or there is a S-CSCF failure, IMS users are assigned to other S-CSCFs, and the network load balance is tweaked. There is neither automated procedure nor standard procedure to regain the network balance among the S-CSCFs. That is, if S-CSCF-1 has two million IMS users being served, and S-CSCF-2, which should be load balancing the IMS registered users with S-CSCF-1, has one thousand users, a new S-CSCF selection performed by I-CSCF will not take that information into account so that new registrations are sent to S-CSCF-2 until the balancing is reached.

An object of embodiments herein is to improve the performance of a communications network by a more efficient discovery and selection of a second IMS node in an IMS network in the communications network.

According to an aspect of embodiments herein, the object is achieved by a method performed by a first Internet Protocol, IP, Multimedia Subsystem, IMS, node for selecting a second IMS node from one or more second IMS nodes in a communications network. The first IMS node and the one or more second IMS nodes are operating in an IMS network.

Upon receiving, from a User Equipment, UE, a registration request message requesting the UE to be registered to the IMS network, the first IMS node obtains, from a subscriber data node subscriber data related to the UE. The subscriber data comprises one or more capabilities associated to a second IMS node to be used in the registration procedure.

The first IMS node sends, to a network node, a request to identify one or more second IMS nodes for the registration procedure, based on the one or more capabilities in the obtained subscriber data. The request comprises the one or more capabilities.

The first IMS node receives a response to the request from the network node. The response comprises selection data related to a selection of a second IMS node from one or more identified second IMS nodes. The one or more identified second IMS nodes supports at least one of the one or more capabilities comprised in the obtained subscriber data.

The first IMS node selects a second IMS node from the one or more identified second IMS nodes for registering the UE to the IMS network. The selecting is based on the received selection data.

The first IMS node proceeds with the registration of the UE by sending a message to the selected second IMS node. The message requests the selected second IMS node to register the UE to the IMS network.

According to another aspect of embodiments herein, the object is achieved by a method performed by a second Internet Protocol, IP, Multimedia Subsystem, IMS, node for assisting a first IMS node in selecting a second IMS node from one or more second IMS nodes in a communications network. The second IMS node and the first IMS node are operating in an IMS network.

During a start-up procedure, the second IMS node registers data associated to the second IMS node in a network node. The data indicates one or more supported capabilities associated to the second IMS node.

The registered data assists the first IMS node to identify the second IMS node and perform a selection of a second IMS node to be used for registering a User Equipment, UE, to the IMS network.

The second IMS node registers the UE by receiving a message from the first IMS node. The message requests the second IMS node to register the UE to the IMS network.

According to another aspect of embodiments herein, the object is achieved by a method performed by network node for assisting a first Internet Protocol, IP, Multimedia Subsystem, IMS, node in selecting a second IMS node from one or more second IMS nodes in a communications network. The second IMS node and the first IMS node are operating in an IMS network.

The network node obtains respective data associated to each of one or more second IMS nodes. For each second IMS node the associated data indicates one or more supported capabilities.

The network node receives, from the first IMS node, a request to identify one or more second IMS nodes for a registration procedure related to a UE. The request comprises one or more capabilities associated to a second IMS node to be used in the registration procedure. The identification is based on the one or more capabilities.

The network node generates selection data related to one or more identified second IMS nodes. The selection data is generated based on the one or more capabilities. The one or more identified second IMS nodes supports at least one of the one or more capabilities.

The network node sends a response to the request to the first IMS node. The response comprises the selection data related to a selection of a second IMS node from the one or more identified second IMS nodes.

According to another aspect of embodiments herein, the object is achieved by a first Internet Protocol, IP, Multimedia Subsystem, IMS, node configured to select a second IMS node from one or more second IMS nodes in a communications network. The first

IMS node and the one or more second IMS nodes are adapted to operate in an IMS network. The first IMS node is further configured to:
Upon receiving, from a User Equipment, UE, a registration request message requesting the UE to be registered to the IMS network, obtain, from a subscriber data node, subscriber data adapted to be related to the UE, which subscriber data is adapted to comprise one or more capabilities associated to a second IMS node to be used in the registration procedure,
send, to a network node, a request to identify one or more second IMS nodes for the registration procedure, based on the one or more capabilities in the obtained subscriber data, which request is adapted to comprise the one or more capabilities,
receive a response to the request from the network node, which response is adapted to comprise selection data related to a selection of a second IMS node from one or more identified second IMS nodes, which one or more identified second IMS nodes are adapted to support at least one of the one or more capabilities comprised in the obtained subscriber data,
select a second IMS node from the one or more identified second IMS nodes for registering the UE to the IMS network, which selecting is adapted to be based on the received selection data, and
proceeding with the registration of the UE by sending a message to the selected second IMS node, which message is adapted to request the selected second IMS node to register the UE to the IMS network.

According to another aspect of embodiments herein, the object is achieved by a second IMS node configured to assist a first IMS node in selecting a second IMS node from one or more second IMS nodes in a communications network. The second IMS node and the first IMS node being adapted to operate in an IMS network. The second IMS node is further configured to:
During a start-up procedure, register data associated to the second IMS node in a network, which data is adapted to indicate one or more supported capabilities associated to the second IMS node,
wherein the registered data is adapted to assist the first IMS node to identify the second IMS node and perform a selection of a second IMS node to be used for registering a User Equipment, UE, to the IMS network.
register the UE by receiving a message from the first IMS node, which message is adapted to request the second IMS node to register the UE to the IMS network.

According to another aspect of embodiments herein, the object is achieved by a network node configured to assist a first Internet Protocol, IP, Multimedia Subsystem, IMS, node in selecting a second IMS node from one or more second IMS nodes in a communications network. The second IMS node and the first IMS node being configured to operate in an IMS network. The network node is further configured to:
obtain respective data associated to each of one or more second IMS nodes, wherein for each second IMS node the associated data is adapted to indicate one or more supported capabilities,
receive, from the first IMS node, a request to identify one or more second IMS nodes for a registration procedure related to a UE, the request adapted to comprise one or more capabilities associated to a second IMS node to be used in the registration procedure, which identification is adapted to be based on the one or more capabilities,
generate selection data related to one or more identified second IMS nodes, which selection data is adapted to be generated based on the one or more capabilities, wherein the one or more identified second IMS nodes is adapted to support at least one of the one or more capabilities, and
send a response to the request to the first IMS node, which response is adapted to comprise the selection data related to a selection of a second IMS node from the one or more identified second IMS nodes.

Thanks to that the first IMS node obtains the subscriber data comprising the one or more capabilities associated to a second IMS node, it is possible for the first IMS node to identify and select a second IMS node for registration of the UE. The first IMS node, during the registration procedure, identifies and selects the second IMS node to be used by requesting the network node to identify the one or more second IMS nodes based on the obtained one or more capabilities. The first IMS node selects the second IMS node based on selection data received from the network node. The first IMS node proceeds with the registration by sending a message to the selected second IMS node. In this way an efficient mechanism for selecting a second IMS node is achieved.

Embodiments herein brings the advantage of an efficient mechanism improving the performance in the communications network. this is achieved by a more efficient discovery, identification and selection of a second IMS node in the communications network, where the first IMS node, based on obtained subscriber data, receives selection data from the network node, and selects a second IMS node based on the received data. the procedure is possible since the one or more second IMS nodes registers its supported capabilities in the network node. This leads to a more efficient selection of second IMS nodes in the IMS network, and results in an improved performance of the communications network.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIG. 2 is a flowchart depicting embodiments of a method in a first IMS node.

FIG. 3 is a flowchart depicting embodiments of a method in a second IMS node.

FIG. 4 is a flowchart depicting embodiments of a method in a network node.

FIG. 5 a and b are signaling diagrams depicting examples of embodiments herein.

FIGS. 6 a and b are schematic block diagrams illustrating embodiments of a first IMS node.

FIGS. 7 a and b are schematic block diagrams illustrating embodiments of a second IMS node.

FIGS. 8 a and b are schematic block diagrams illustrating embodiments of a network node.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11 to 14 are flowcharts illustrating methods implemented in a communication system including a host computer, a base station and a user equipment.

### DETAILED DESCRIPTION

Embodiments herein relate to a communications network and the selection of a second IMS nodes servers in an IMS network.

As mentioned above, the object of embodiments herein is to improve the performance of a communications network by a more efficient discovery and selection of a second IMS node in an IMS network in the communications network.

Examples of embodiments herein may e.g. bring the advantage of enabling automation of S-CSCF selection and discovery in the IMS network. This may be achieved by introducing the use of a Network Repository Function (NRF) in this procedure, and the enhancement of initial Filter Criteria (iFC) data. Further, examples of embodiments herein may e.g. bring the advantage of a harmonized alignment of the IMS network with the 5G Core (5GC) routing selection and discovery. Yet further, examples of embodiments herein may e.g. bring the advantage of an automated handling of a scale out of S-CSCFs. This since the NRF may notify all I-CSCFs which subscribes to IMS AS Network Function (NF) profile changes. Thus, a new S-CSCFs is immediately taken into account for new IMS registrations to allocated to an S-CSCF. Yet further, examples of embodiments herein may e.g. bring the advantage of dynamic load balancing of the S-CSCFs due to NRF capabilities. Exemplified, this may mean that if the S-CSCFs update the load in their NF profile towards NRF when certain thresholds. As an example with 100000 buckets of users, 100000->5% load, 200000->10% load, 300000->15% load. When such thresholds are reached and/or crossed, the NRF may take the load information into account, in addition to mandatory and/or optional capabilities. This may achieve that when several S-CSCFs are eligible at S-CSCF discovery, the NRF may return the discovered S-CSCFs sorted by priority with lower load in order to keep the network balanced in an automated manner.

FIG. 1 is a schematic overview depicting a communications network 100 wherein embodiments herein may be implemented. The communications network 100 comprises one or more RANs and one or more CNs. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

The communications network 100 further comprises an IMS network 105, in which IMS network 105 an IMS node, such as e.g. the first IMS node 110, and one or more second IMS nodes, such as e.g., the second IMS nodes 131, 132, 133, operates. According to embodiments herein the first IMS node 110 may be an Interrogating Call Session Control Function (I-CSCF) and the second IMS nodes 131, 132, 133 may Serving Call Session Control Functions (S-CSCF). The IMS network 105 is an architecture for delivering media content over an IP packet switched transport.

One or more UEs operate in the communication network 100, such as e.g. the UE 121. The UE 121 may e.g. be 5G-RG, a UE, a remote UE, a wireless device, an NR device, a mobile station, a wireless terminal, an NB-IoT device, an MTC device, an eMTC device, a CAT-M device, a WiFi device, an LTE device and an a non-access point (non-AP) STA, a STA, that communicates via a base station such as e.g. a base station 105, one or more Access Networks (AN), e.g. a RAN, to one or more core network (CN) nodes, in one or more CNs, one or more IMS nodes, such as e.g. the IMS node 110, or one or more application servers, such as e.g. the application server 131, 132, 133, in the IMS network 105. The UE 121 may communicate with one or more CN nodes, or IMS nodes, such as the first IMS node 110 and the second IMS nodes 131, 132, 133, by a fixed network connection, such as e.g. cable and/or optical fiber. It should be understood by the skilled in the art that “UE” is a non-limiting term which means any terminal, client, mobile client, IMS client, wireless communication terminal, user equipment, Device to Device (D2D) terminal, or node e.g. smart phone, laptop, mobile phone, sensor, relay, mobile tablets or even a car or any small base station communicating within a cell.

Subscriber data nodes, such as e.g. a subscriber data node 140, may operate in the communications network 100. The subscriber data node 140 may e.g. operate in the IMS network 105, the CN, or be connected to said IMS network 105 or CN. The subscriber data node 140 stores and manages subscriber data related to UEs, such as e.g. the first UE 121. According to embodiments herein the subscriber data node 140 may be a Home Subscriber Server (HSS).

Network nodes, such as e.g. the network node 150, may operate in the communications network 100. The network node 150 may e.g. operate in the CN. The network node may provide service registration and discovery functions to network functions in the communications network 100. According to embodiments herein the network node 150 may be an NRF.

Base stations such as the base station 101, operate in the wireless communications network 100. The base station 101 provides one or more cells such as a first cell 11. The base station 101 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs, such as the terminal 120, within the first cell 11, served by the base station 101. The base station 101 may be referred to as a serving radio network node and communicates with the terminal 120 with Downlink (DL) transmissions to the terminal 120 and Uplink (UL) transmissions from the terminal 120.

Methods according to embodiments herein are performed by the IMS node 110, and the application server 131, 132, 133. These nodes may be Distributed Nodes (DN)s and functionality, e.g. comprised in a cloud 160 as shown in FIG. 1 may be used for performing or partly performing the methods.

Examples of embodiments herein allows nodes in the IMS network 105, such as the first IMS node 110, to discover, identify and select S-CSCFs, such as the second IMS node 131, 132, 133, e.g. by using the 5GC capabilities for routing, selection and discovery. Thus, the procedure may be improved by leveraging the 5GC NRF, such as the network node 150, capabilities, an replacing legacy mechanisms which require a lot of O&M tasks.

Example of embodiments herein may provide methods for discovery, identification and selection of a second IMS node 131, 132, 133. When an S-CSCF, such as the second IMS node 131, 132, 133, starts, it may register its NF profile in a network node, such as the network node 150. The profile may comprise the capabilities supported by the second IMS node 131, 132, 133. The profile may further comprise the IP address, such as the Mw IP address, the Mw Fully Qualified Domain Name (FQDN), the locality and the load of the second IMS node 131, 132, 133.

Further, examples of embodiments herein may provide methods for discovery, identification and selection of a second IMS node 131, 132, 133. When the first IMS node 110 receives the capabilities, e.g. at IMS registration, of the UE 121, from the subscriber data node 140, such as the HSS, the first IMS node 110 queries, such as requests, the network node 150, such as the NRF, to discover, such as identify, the second IMS nodes 131, 132, 133 which are eligible in the IMS network. The discovery request towards network node 150 comprises the one or more capabilities, e.g. mandatory and/or optional capabilities, to be supported by the second IMS node 131, 132, 133, this so that the network node 150 may filter out those second IMS nodes not meeting the criteria and e.g. prioritize the second IMS nodes supporting matching as many optional capabilities as possible.

Yet further, examples of embodiments herein may allow the first IMS node 110 to receive selection data, e.g. comprising the prioritized list of second IMS nodes 131, 132, 133, from the network node 150. The first IMS node 110 may then select the most prioritized second IMS node, e.g. the second IMS node 131, and may include data received in the NF profile in a message sent to the selected second IMS node 131 for registering the user. The data may e.g. be the top-most SIP route header, such as a SIP next-hop header. The header may take the value Mw IP address.

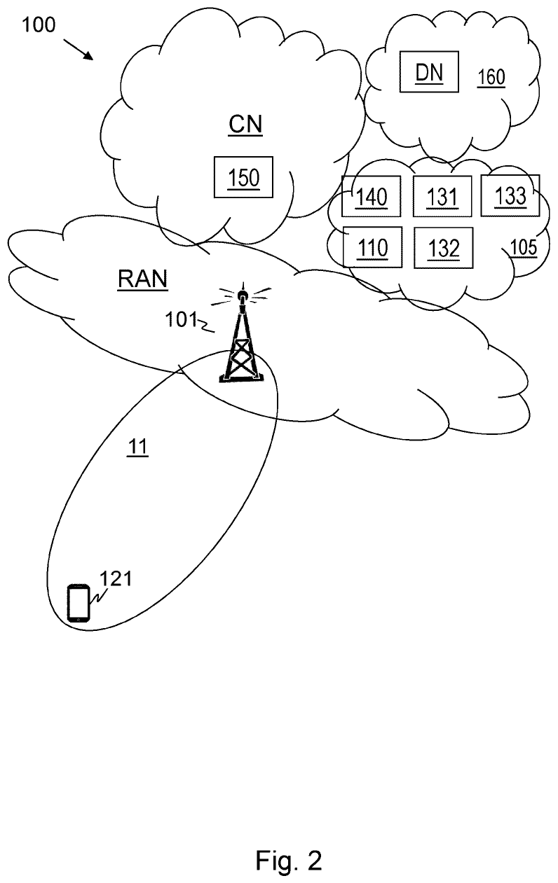

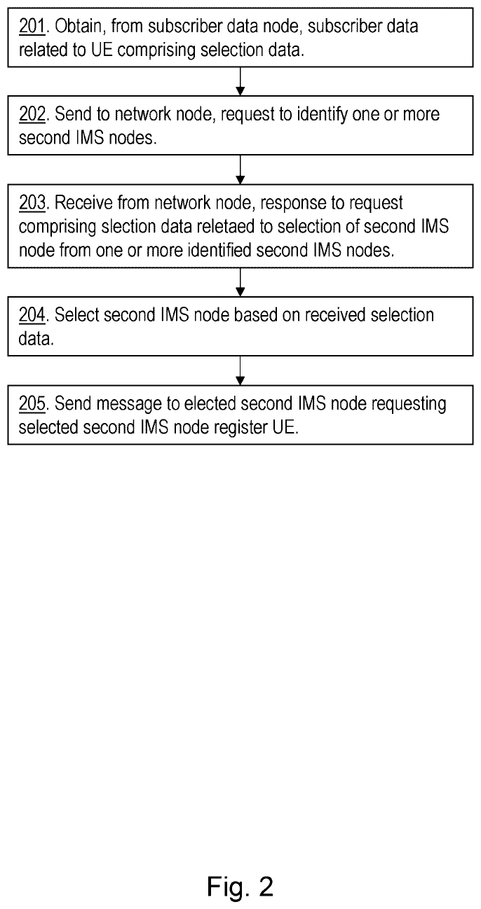

A method according to embodiments will now be described from the view of the first IMS node 110 together with FIG. 2.

Example embodiments of a method performed by the first IMS node 110 for selecting a second IMS node 131 from one or more second IMS nodes 131, 132, 133 in a communications network 100, will now be described with reference to a flowchart depicted in FIG. 2. The first IMS node 110 and the one or more second IMS nodes 131, 132, 133 are operating in an IMS network 105. Any one or more out of: The network node 150 is a 5GC NRF node 150, the first IMS node 110 is an I-CSCF 110, the subscriber data node 140 is an HSS 140, and the one or more second IMS nodes 131, 132, 133 is a S-CSCF 131, 132, 133.

The method comprises the following actions, which actions may be taken in any suitable order. Actions that are optional are presented in dashed boxes in FIG. 2.

### Action 201

Upon receiving, from the UE 121, a registration request message requesting the UE 121 to be registered to the IMS network 105, the first IMS node 110 obtains subscriber data related to the UE 121 from a subscriber data node 140. The subscriber data comprises one or more capabilities associated to a second IMS node to be used in the registration procedure.

Different types of UEs, such as the UE 121, may require different capabilities of a second IMS node. In some embodiments, the one or more capabilities indicates any one or more out of: One or more optional capabilities, and one or more mandatory capabilities,

A mandatory capability when used herein, may mean a capability that is required to be supported by the second IMS node selected for registering the UE 121 to the IMS network 105. An optional capability when used herein, may mean a capability that is preferred, but not required, to be supported by the second IMS node.

### Action 202

To select a second IMS node to used, one or more second IMS nodes needs to be identified.

The first IMS node 110 sends a request to the network node 150. The request requests the network node 150 to identify one or more second IMS nodes for the registration procedure. The identification is based on the one or more capabilities in the obtained subscriber data. The request comprises the one or more capabilities,

In some embodiments, the request comprises a preferred locality of the one or more second IMS nodes to be identified.

The preferred locality may e.g. be the same as the locality of the first IMS node 110, or it may be a different locality. A locality may e.g. mean the region of the IMS network 105 that first IMS node 110 and/or the second IMS node is located in. E.g. the IMS network 105 may be divided in three regions, such as ‘east’, ‘west’ and ‘central’. When the first IMS node 110 is located in the east region, the locality of the first IMS node 110 is ‘east’. In such an example, the preferred locality of the one or more second IMS nods to be identified may also be east. This since the latency for communication between the first IMS node 110 and the one or more second IMS nodes may be reduced if they are geographically located nearer each other.

### Action 203

The first IMS node 110 receives a response to the request from the network node 150. The response comprises selection data related to a selection of a second IMS node from one or more identified second IMS nodes 131, 132, 133. The one or more identified second IMS nodes 131, 132, 133 supports at least one of the one or more capabilities comprised in the obtained subscriber data. The selection data may e.g. be a list of the one or more identified second IMS node.

In some embodiments, the selection data indicates, for each of the identified one or more second IMS nodes 131, 132, 133, a priority related to selection of a second IMS node. The priority of the one or more second IMS nodes 131, 132, 133 may e.g. be based on any one or more out of: The locality of the one or more second IMS nodes 131, 132, 133, the optional capabilities supported by the one or more second IMS nodes 131, 132, 133, and the load of the one or more second IMS nodes 131, 132, 133. The priority may indicate to the first IMS node 110 which of the one or more identified application servers 131, 132, 133 is the most preferred second IMS node, which is the second most preferred second IMS node etc. E.g. a second IMS node may be given a higher priority when supporting a larger number of optional capabilities. If the number of optional capabilities supported is the same for two or more second IMS nodes, and the locality is the same, and the load is the same, the priority of each second IMS node is determined by a priority in data associated to each second IMS node 131, 132, 133 and registered in the network node 150. The associated data may be a profile, such as e.g. an NF profile.

The response may further comprise the FQDN and/or the IP address of each of the identified second IMS nodes 131, 132, 133.

### Action 204

The first IMS node 110 selects a second IMS node 131 from the one or more identified second IMS nodes 131, 132, 133 for registering the UE 121 to the IMS network 105. The first IMS node 110 selects the second IMS node 131 based on the received selection data.

In some embodiments, selecting the second IMS node 131 comprises selecting the second IMS node from the one or more identified second IMS nodes 131, 132, 133 with the highest priority according to the selection data. As mentioned above, the priority may indicate to the first IMS node 110 which of the one or more identified application servers 131, 132, 133 is the most preferred second IMS node, which is the second most preferred second IMS node etc. E.g. a second IMS node may be given a higher priority when supporting more optional capabilities.

### Action 205

The first IMS node 110 proceeds with the registration of the UE 121 by sending a message to the selected second IMS node 131. The message requests the selected second IMS node 131 to register the UE 121 to the IMS network 105.

In some embodiments, the message is a SIP REGISTER message. The message may e.g. comprise an FQDN and/or the IP address of the selected second IMS node 131 in a header of the message.

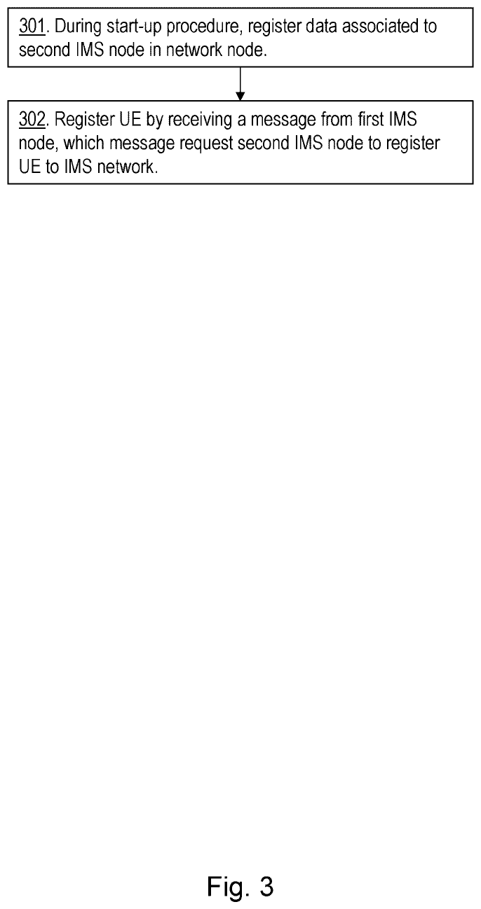

A method according to embodiments will now be described from the view of the second IMS node 131, 132, 133 together with FIG. 3.

Example embodiments of a method performed by the second IMS node 131, 132, 133 for or assisting a first IMS node 110 in selecting a second IMS node from one or more second IMS nodes 131, 132, 133 in a communications network 100, will now be described with reference to a flowchart depicted in FIG. 3. The first IMS node 110 and the one or more second IMS nodes 131, 132, 133 are operating in an IMS network 105. Any one or more out of: The network node 150 is a 5GC NRF node 150, the first IMS node 110 is an I-CSCF 110, and the one or more second IMS nodes 131, 132, 133 is a S-CSCF 131, 132, 133.

The method comprises the following actions, which actions may be taken in any suitable order. Actions that are optional are presented in dashed boxes in FIG. 3.

### Action 301

During a start-up procedure, the second IMS node 131, 132, 133 registers data associated to the second IMS node 131, 132, 133 in the network node 150. The data indicates one or more supported capabilities associated to the second IMS node 131, 132, 133. The registered data assists the first IMS node 110 to identify the second IMS node 131, 132, 133 and perform a selection of a second IMS node to be used for registering the UE 121 to the IMS network 105. This may e.g. mean that the second IMS node 131, 132, 133 sends, provides and/or transmits the data to the network node 150. The data may be registered as a profile in the network node 150, such as e.g. an NF profile.

In some embodiments, the data associated to the second IMS node 131, 132, 133 further comprises a Fully Qualified Domain Name, FQDN, related to the second IMS node 131, 132, 133.

The data associated to the second IMS node 131, 132, 133 may e.g. indicate any one or more out of: A load of the second IMS node 131, 132, 133 and the locality of the second IMS node 131, 132, 133.

As mentioned above, the locality may e.g. mean the region of the IMS network 105 that second IMS node 131, 132, 133 is located in. E.g. the IMS network 105 may be divided in three regions, such as ‘east’, ‘west’ and ‘central’. When the second IMS node 131, 132, 133 is located in the east region, the locality of the second IMS node 131, 132, 133 is ‘east’. The second IMS node 131, 132, 133 may send updated load indications to the network node 150. The updated load indications may e.g. be sent periodically and/or aperiodically. When sent aperiodically, the updated load indication may e.g. be sent when the load crosses a threshold. There may be one or more thresholds configured to trigger the second IMS node 131, 132, 133 to send the updated load indication.

### Action 302

The second IMS node 131, 132, 133 registers the UE 121 by receiving a message from the first IMS node 110. The message requests the second IMS node 131, 132, 133 to register the UE 121 to the IMS network 105. In some embodiments, the message is a SIP REGISTER message. The message may e.g comprise an FQDN and/or IP address of the selected second IMS node 131 in a header of the message. Based on the received message, the second IMS node 131, 132, 133 may proceed with registering the UE 121.

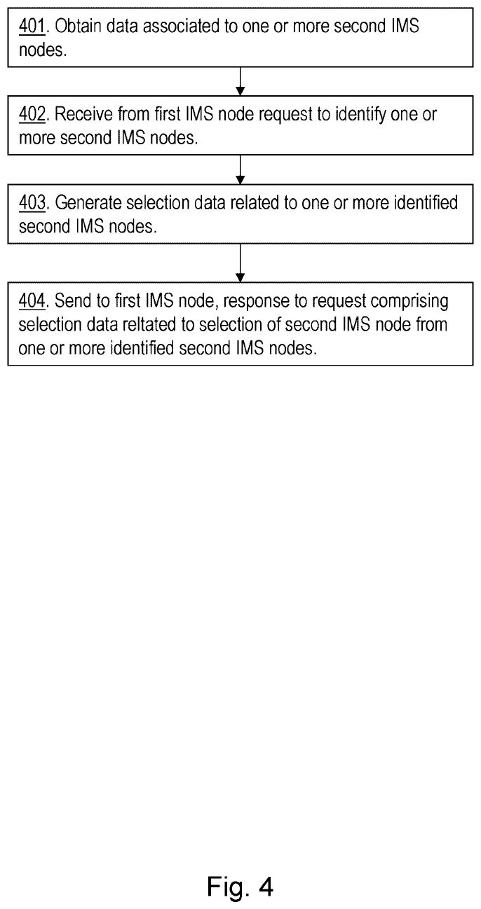

A method according to embodiments will now be described from the view of the network node 150 together with FIG. 4.

Example embodiments of a method performed by the network node 150 for assisting the first IMS node 110 in selecting a second IMS node from one or more second IMS nodes 131, 132, 133 in the communications network 100, will now be described with reference to a flowchart depicted in FIG. 4. The first IMS node 110 and the one or more second IMS nodes 131, 132, 133 are operating in the IMS network 105. Any one or more out of: The network node 150 is a 5GC NRF node 150, the first IMS node 110 is an I-CSCF 110, and the one or more second IMS nodes 131, 132, 133 is a S-CSCF 131, 132, 133.

The method comprises the following actions, which actions may be taken in any suitable order. Actions that are optional are presented in dashed boxes in FIG. 4.

### Action 401

The network node 150 obtains respective data associated to each of one or more second IMS nodes 131, 132, 133. For each second IMS node 131, 132, 133 the associated data indicates one or more supported capabilities. This may e.g. mean that the network node 150 receives the respective data from each of the one or more second IMS nodes 131, 132, 133. For each of the one or more second IMS node 131, 132, 133, the network node 150 may register the obtained data. The data may be registered as a profile, such as e.g. an NF profile, in the network node 150.

In some embodiments, the respective data further indicates a load of the associated second IMS node 131, 132, 133. The network node 150 may receive updated load indications from the one or more second IMS nodes 131, 132, 133. The updated load indications may e.g. be received periodically and/or aperiodically. When received aperiodically, the updated load indication may e.g. be received when the load of a second IMS node crosses a threshold. There may be one or more thresholds configured to trigger a second IMS node to send the updated load indication.

### Action 402

The network node 150 receives, from the first IMS node 110, a request to identify one or more second IMS nodes for a registration procedure related to the UE 121. The request comprises one or more capabilities associated to a second IMS node to be used in the registration procedure. The identification is based on the one or more capabilities.

In some embodiments, the one or more capabilities comprises at least one mandatory capability. The one or more capabilities may indicate any one or more out of: One or more mandatory capabilities, and one or more optional capabilities.

The request may comprise a preferred locality of the one or more second IMS nodes to be identified. As mentioned above, the locality may e.g. mean the region of the IMS network 105 that second IMS node 131, 132, 133 is located in. E.g. the IMS network 105 may be divided in three regions, such as ‘east’, ‘west’ and ‘central’. When the second IMS node 131, 132, 133 is located in the east region, the locality of the second IMS node 131, 132, 133 is ‘east’. In such an example, the preferred locality of the one or more second IMS nods to be identified may also be east. This since the latency for communication between the first IMS node 110 and the one or more second IMS nodes may be reduced if they are geographically located nearer each other.

### Action 403

The network node 150 generates selection data related to one or more identified second IMS nodes 131, 132, 133. The selection data is generated based on the one or more capabilities. The one or more identified second IMS nodes 131, 132, 133 supports at least one of the one or more capabilities. The selection data may e.g. be a list of the one or more identified second IMS nodes 131, 132, 133.

In some embodiments, the network node 150 generates the selection data by further identifying the one or more second IMS nodes 131, 132, 133 based on the one or more capabilities. The identified one or more second IMS nodes 131, 132, 133 supports the at least one of the at least one of the mandatory capability.

This may e.g. mean that the network node 150 filters out any second IMS node 131, 132, 133 that does not support any of the mandatory capabilities in the one or more capabilities. To filter out a second IMS node may mean that it is excluded from the generated selection data, such as the list of second IMS nodes that may be selected.

The selection data may indicate a priority of the one or more identified second network nodes 131, 132, 133. As mentioned above, the priority of the one or more second IMS nodes 131, 132, 133 may e.g. be based on any one or more out of: The locality of the one or more second IMS nodes 131, 132, 133, the capabilities supported by the one or more second IMS nodes 131, 132, 133, and the load of the one or more second IMS nodes 131, 132, 133. The network node 150 may determine the priority. The priority may indicate to the first IMS node 110 which of the one or more identified application servers 131, 132, 133 is the most preferred second IMS node, which is the second most preferred second IMS node etc. E.g. a second IMS node may be given a higher priority when supporting a larger number of optional capabilities. If the number of optional capabilities supported is the same for two or more second IMS nodes, and the locality is the same, and the load is the same, the priority of each second IMS node is determined by a priority in the obtained data, such as e.g. the profile, for each of the one or more second IMS node 131, 132, 133. The profile may e.g. be an NF profile.

### Action 404

The network node 150 sends a response to the request to the first IMS node 110. The response comprises the selection data related to a selection of a second IMS node from the one or more identified second IMS nodes 131, 132, 133.

The selection data may, as mention above, indicate a priority of each of the identified one or more second IMS nodes 131, 132, 133.

Embodiments mentioned above will now be further described and exemplified. The embodiments below is applicable to and may be combined with any suitable embodiment described above.

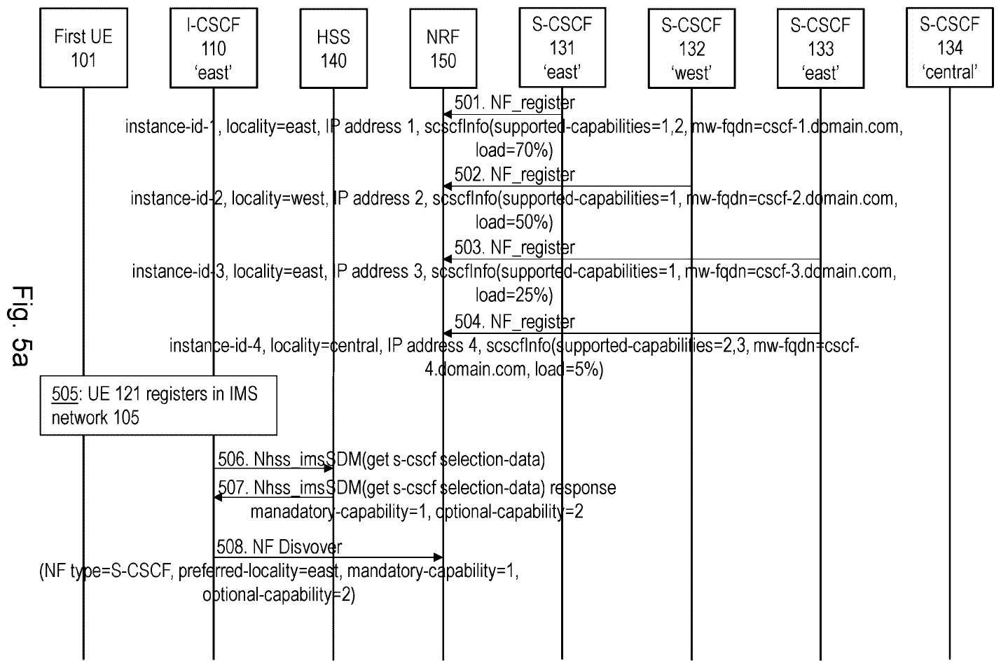

FIGS. 5a and b shows an example of embodiments herein. In the examples of FIGS. 5a and b, the first IMS node 110 may be referred to as e.g. the I-CSCF 110, the one or more second IMS nodes 131, 132, 133 may be referred to as e.g. the S-CSCF 131, 132, 133, the subscriber data node 140 may be referred to as HSS 140 and the network node 150 may be referred to as e.g. the NRF 150. FIG. 5a and b also shows a fourth second IMS node referred to as S-CSCF 134.

In actions 501-504, the S-CSCF 131, 132, 133, 134, such as e.g. the second IMS node 131, 132, 133, starts up and registers its NF profile, such as e.g. data associated to the second IMS node 131, 132, 133, with the NRF 150, such as e.g. the network node 150.

501. The S-CSCF 131 registers its NF profile, such as data associated to the S-CSCF 131, with the NRF 150 by sending a message, such as a NF_register message, to the NRF 150. The NF profile comprises data associated to the S-CSCF 131, such as the one or more capabilities supported by the S-CSCF 131. The NF profile may further comprise any of or more out of: locality, load, instance ID and contact information, e.g. IP address and/or FQDN of the S-CSCF 131.

This action may be related to, and combined with, Actions 301 and 401 described above.

502. The S-CSCF 132 registers its NF profile, such as data associated to the S-CSCF 132, with the NRF 150 by sending a message, such as a NF_register message, to the NRF 150. The NF profile comprises data associated to the S-CSCF 132, such as the one or more capabilities supported by the S-CSCF 132. The NF profile may further comprise any of or more out of: locality, load, instance ID and contact information, e.g. IP address and/or FQDN of the S-CSCF 132.

This action may be related to, and combined with, Actions 301 and 401 described above.

503. The S-CSCF 133 registers its NF profile, such as data associated to the S-CSCF 133, with the NRF 150 by sending a message, such as a NF_register message, to the NRF 150. The NF profile comprises data associated to the S-CSCF 133, such as the one or more capabilities supported by the S-CSCF 133. The NF profile may further comprise any of or more out of: locality, load, instance ID and contact information, e.g. IP address and/or FQDN of the S-CSCF 133.

This action may be related to, and combined with, Actions 301 and 401 described above.

504. The S-CSCF 134 registers its NF profile, such as data associated to the S-CSCF 134, with the NRF 150 by sending a message, such as a NF_register message, to the NRF 150. The NF profile comprises data associated to the S-CSCF 134, such as the one or more capabilities supported by the S-CSCF 134. The NF profile may further comprise any of or more out of: locality, load, instance ID and contact information, e.g. IP address and/or FQDN of the S-CSCF 134.

This action may be related to, and combined with, Actions 301 and 401 described above.

505. The UE 121 registers to the IMS network 105 by performing a IMS registration procedure.

This action may be related to, and combined with, Action 201 described above.

506. The I-CSCF 110, such as the first IMS node 110, requests the subscriber data related to the UE 121 by sending a message, such as e.g. a Nhss_imsSDM message to the HSS 140, such as the subscriber data node 140. The message may comprise an indication indicating that the I-CSCF 110 request S-CSCF selection data. The indication may e.g. be a get s-cscf selection-data indication.

This action may be related to, and combined with, Action 201 described above.

507. The I-CSCF 110 receives a response, such as obtains the subscriber data related to the UE 121, such as e.g. a Nhss_imsSDM response message, comprising the requested subscriber data, such as the subscriber data comprising the one or more capabilities associated to a second IMS node to be used in the registration procedure, from the HSS 140. The one or more capabilities may comprise one or more mandatory capabilities and/or one or more optional capabilities.

This action may be related to, and combined with, Action 201 described above.

508. The I-CSCF 110 discovers, such as identifies, the one or more S-CSCF 131, 132, 133 by sending a message, such as the request to identify the one or more second IMS nodes 131, 132, 133, 134, to the network node 150. The message may e.g. be an NF Discover message. The message comprises the one or more capabilities obtained in the subscriber data. The message may indicate which of the one or more capabilities that are mandatory and which are optional. The optional capabilities may be preferred optional capabilities. The message may comprise at least one mandatory capability.

This action may be related to, and combined with, Actions 202 and 402 described above.

509. The NRF 150 generates selection data based on the received one or more capabilities. The selection data comprises one or more identified S-CSCF 131, 132, 133, 134 that supports at least one of the one or more capabilities. The NRF 150 may identify the one or more S-CSCF 131, 132, 133, 134 by filtering out all available S-CSCFs that does not support the one or more capabilities, such as filtering out any S-CSCF that does not support the at least one mandatory capability. The NRF may further prioritize the identified S-CSCF 131, 132, 133, 134. The priority may be based on one or more out of: The number of supported optional capabilities, the load, and the locality, of the identified one or more S-CSCF 131, 132, 133, 134. As an example, the NRF 150 determines to prioritize based on load, and thus indicates that S-CSCF 131 has priority 1, the highest priority, S-CSCF 132 has priority 2 and S-CSCF 133 has priority 3. S-CSCF 134 has been filtered out since it does not support the mandatory capability 1.

This action may be related to, and combined with, Action 403 described above. 510. The I-CSCF 110 receives a response, such as the response to the request, from the NRF 150. The message may e.g. be a NF Discover response message. The response comprises the selection data generated by the NRF 150.

This action may be related to, and combined with, Actions 203 and 404 described above.

511. Based on the received selection data, the I-CSCF 110 selects the S-CSCF 131 to serve the UE 121, such for register the UE 121 to the IMS network 105. The S-CSCF 131 is selected since it in this example has the highest priority according to the received selection data.

This action may be related to, and combined with, Action 204 described above.

512. The I-CSCF 110 sends a message to the selected S-CSCF 131 for registering the UE 121 to the IMS network. The message may be a SIP REGISTER message. The message may comprise the FQDN, such as the mw-fqdn, associated to the selected S-CSCF 131 in the top-most route header, e.g. the SIP next-hop header, of the message.

This action may be related to, and combined with, Action 205 described above.

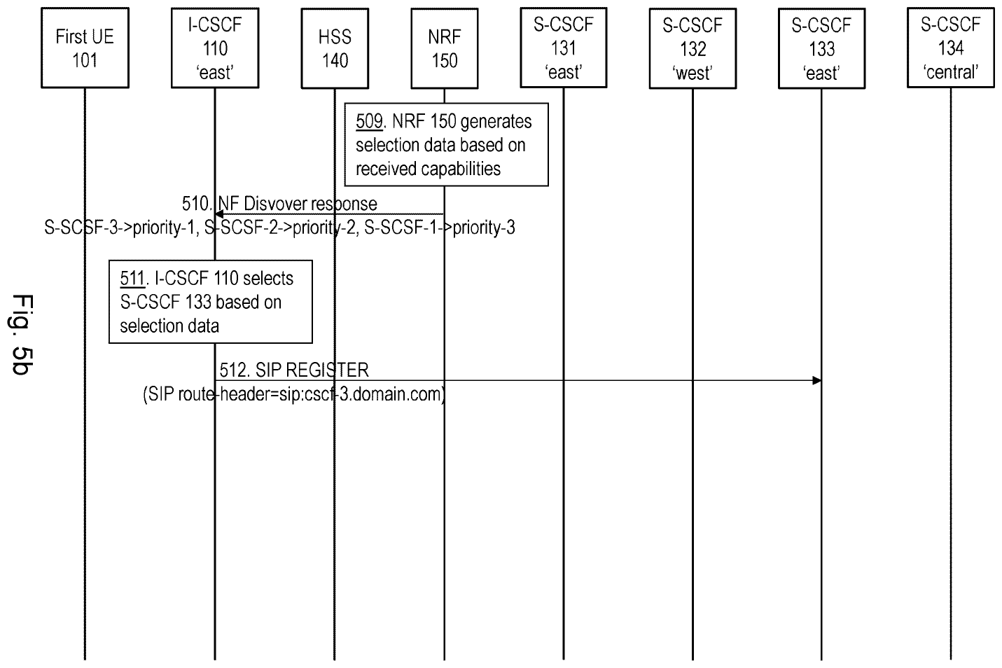

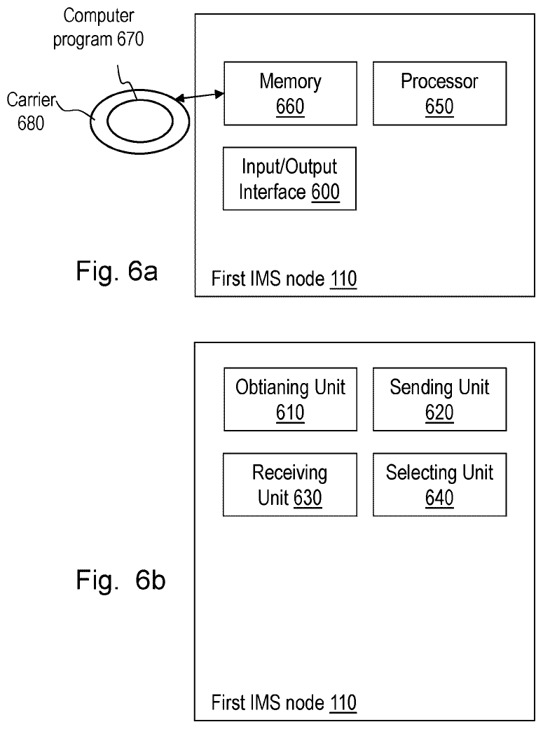

To perform the method actions, the first IMS node 110 may comprise an arrangement depicted in FIG. 6a and b. The first node 110 is configured to select a second IMS node 131 from one or more second IMS nodes 131, 132, 133 in a communications network 100. The first IMS node 110 and the one or more second IMS nodes 131, 132, 133 are adapted to operate in the IMS network 105.

Any one or more out of: The network node 150 may be a 5GC NRF node 150, the one or more second IMS node 131, 132, 133 may be an S-CSCF 131, 132, 133, and the first IMS node 110 may be an I-CSCF 110.

The first IMS node 110 may comprise an input and output interface 600 configured to communicate with e.g. the UE 121, the subscriber data node 140, the network node 150, the one or more second IMS nodes 131, 132, 133 and with network nodes in the communications network 100 and the IMS network 105.

The first IMS node 110 is further configured to, e.g. by means of an obtaining unit 610 in the first IMS node 110, upon receiving, from the UE 121, a registration request message requesting the UE 121 to be registered to the IMS network 105, obtain, from the subscriber data node 140, subscriber data adapted to be related to the UE 121. The subscriber data is adapted to comprise one or more capabilities associated to a second IMS node to be used in the registration procedure.

The one or more capabilities may further be adapted to indicate any one or more out of: One or more optional capabilities, and one or more mandatory capabilities.

The first IMS node 110 is further configured to, e.g. by means of a sending unit 620 in the first IMS node 110, send, to a network node 150, a request to identify one or more second IMS nodes for the registration procedure, based on the one or more capabilities in the obtained subscriber data. The request is adapted to comprise the one or more capabilities.

The request may comprise a preferred locality of the one or more second IMS nodes to be identified.

The first IMS node 110 is further configured to, e.g. by means of the sending unit 620 in the first IMS node 110, proceeding with the registration of the UE 121 by sending a message to the selected second IMS node 131. The message is adapted to request the selected second IMS node 131 to register the UE 121 to the IMS network 105.

The first IMS node 110 is further configured to, e.g. by means of a receiving unit 630 in the first IMS node 110, receive a response to the request from the network node 150. The response is adapted to comprise selection data related to a selection of a second IMS node from one or more identified second IMS nodes 131, 132, 133. The one or more identified second IMS nodes 131, 132, 133 are adapted to support at least one of the one or more capabilities comprised in the obtained subscriber data.

The selection data may be adapted to indicate, for each of the identified one or more second IMS nodes 131, 132, 133, a priority related to selection of a second IMS node.

The first IMS node 110 is further configured to, e.g. by means of a selecting unit 640 in the first IMS node 110, select a second IMS node 131 from the one or more identified second IMS nodes 131, 132, 133 for registering the UE 121 to the IMS network 105. The selecting is adapted to be based on the received selection data.

The first IMS node 110 may further be configured to, e.g. by means of the selecting unit 640 in the first IMS node 110, select the second IMS node 131 by selecting a second IMS node from the one or more identified second IMS nodes 131, 132, 133 with the highest priority according to the selection data.

The embodiments herein may be implemented through a respective processor or one or more processors, such as the processor 650 of a processing circuitry in the first IMS node 110 depicted in FIG. 6a, together with respective computer program code for performing the functions and actions of the embodiments herein. The program code mentioned above may also be provided as a computer program product, for instance in the form of a data carrier carrying computer program code for performing the embodiments herein when being loaded into the first IMS node 110. One such carrier may be in the form of a CD ROM disc. It is however feasible with other data carriers such as a memory stick. The computer program code may furthermore be provided as pure program code on a server and downloaded to the first IMS node 110.

The first IMS node 110 may further comprise a memory 660 comprising one or more memory units. The memory comprises instructions executable by the processor 650 in the first IMS node 110. The memory 660 is arranged to be used to store e.g. information, messages, indications, subscriber data, data, profile data, selection data, service requests, connections, identities, communication data and applications and applications to perform the methods herein when being executed in the first IMS node 110.

In some embodiments, a computer program 670 comprises instructions, which when executed by the respective at least one processor 650, cause the at least one processor 650 of the first IMS node 110 to perform the actions above.

In some embodiments, a respective carrier 680 comprises the respective computer program 670, wherein the carrier 680 is one of an electronic signal, an optical signal, an electromagnetic signal, a magnetic signal, an electric signal, a radio signal, a microwave signal, or a computer-readable storage medium.

Those skilled in the art will appreciate that the units in the first IMS node 110 described above may refer to a combination of analog and digital circuits, and/or one or more processors configured with software and/or firmware, e.g. stored in the I first IMS node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

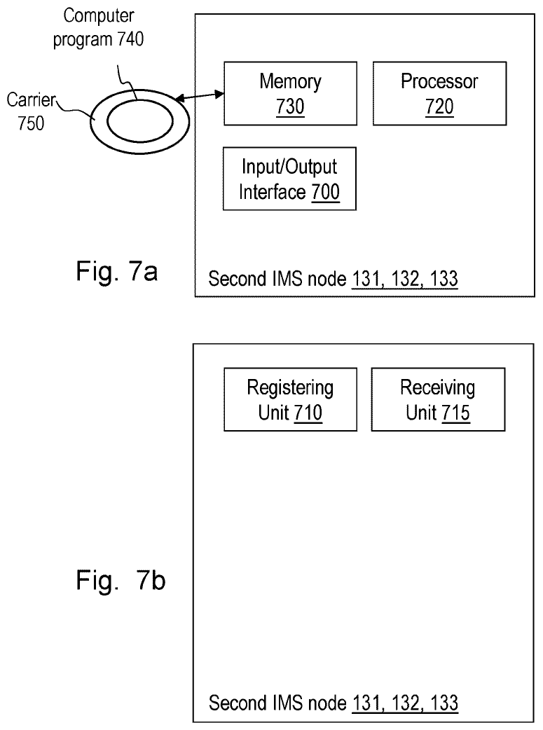

To perform the method actions, the second IMS node 131, 132, 133 may comprise an arrangement depicted in FIG. 7a and b. The second IMS node 131, 132, 133 is configured to assist the first IMS node 110 in selecting a second IMS node from one or more second IMS nodes 131, 132, 133 in a communications network 100. The second IMS node 131, 132, 133 and the first IMS node 110 are adapted to operate in the IMS network 105. Any one or more out of: The network node 150 may be a 5GC NRF node 150, the one or more second IMS node 131, 132, 133 may be an S-CSCF 131, 132, 133, and the first IMS node 110 may be an I-CSCF 110.

The second IMS node 131, 132, 133 may comprise an input and output interface 700 configured to communicate with e.g. the first IMS node 110, the network node 150, the UE 121 and with network nodes in the communications network 100 and the IMS network 105.

The second IMS node 131, 132, 133 is further configured to, e.g. by means of a registering unit 710 in the second IMS node 131, 132, 133, during a start-up procedure, register data associated to the second IMS node 131, 132, 133 in the network node 150. The data is adapted to indicate one or more supported capabilities associated to the second IMS node 131, 132, 133. The registered data is adapted to assist the first IMS node 110 to identify the second IMS node 131, 132, 133 and perform a selection of a second IMS node to be used for registering a UE 121 to the IMS network 105.

The data associated to the second IMS node 131, 132, 133 may further be adapted to comprise an FQDN related to the second IMS node 131, 132, 133.

The second IMS node 131, 132, 133 is further configured to, e.g. by means of a receiving unit 715 in the second IMS node 131, 132, 133, register the UE 121 by receiving a message from the first IMS node 110. The message is adapted to request the second IMS node 131, 132, 133 to register the UE 121 to the IMS network 105.

The embodiments herein may be implemented through a respective processor or one or more processors, such as the processor 720 of a processing circuitry in the second IMS node 131, 132, 133 depicted in FIG. 7a, together with respective computer program code for performing the functions and actions of the embodiments herein. The program code mentioned above may also be provided as a computer program product, for instance in the form of a data carrier carrying computer program code for performing the embodiments herein when being loaded into the second IMS node 131, 132, 133. One such carrier may be in the form of a CD ROM disc. It is however feasible with other data carriers such as a memory stick. The computer program code may furthermore be provided as pure program code on a server and downloaded to the second IMS node 131, 132, 133.

The second IMS node 131, 132, 133 may further comprise a memory 730 comprising one or more memory units. The memory 730 comprises instructions executable by the processor 720 in the second IMS node 131, 132, 133. The memory 730 is arranged to be used to store e.g. information, messages, indications, subscriber data, data, profile data, selection data, service requests, connections, identities, communication data and applications to perform the methods herein when being executed in the second IMS node 131, 132, 133.

In some embodiments, a computer program 740 comprises instructions, which when executed by the respective at least one processor 720, cause the at least one processor 720 of the second IMS node 131, 132, 133 to perform the actions above.

In some embodiments, a respective carrier 750 comprises the respective computer program 740, wherein the carrier 750 is one of an electronic signal, an optical signal, an electromagnetic signal, a magnetic signal, an electric signal, a radio signal, a microwave signal, or a computer-readable storage medium.

Those skilled in the art will appreciate that the units in the second IMS node 131, 132, 133 described above may refer to a combination of analog and digital circuits, and/or one or more processors configured with software and/or firmware, e.g. stored in the second IMS node 131, 132, 133, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

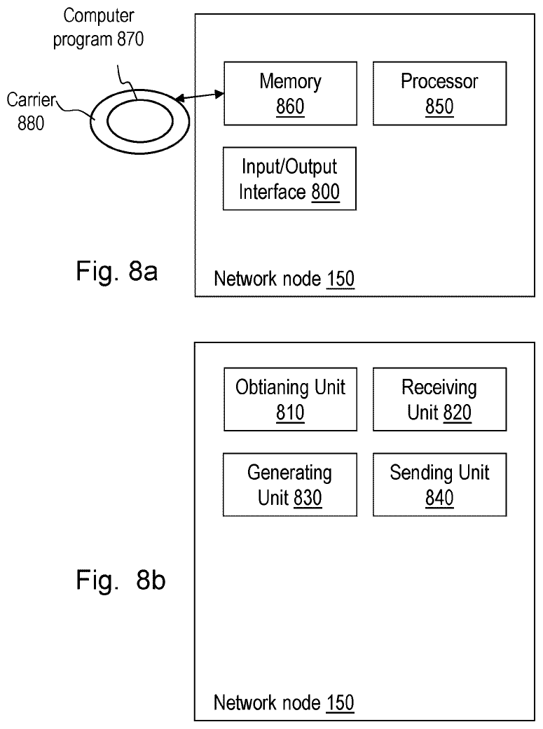

To perform the method actions, the second IMS node 131, 132, 133 may comprise an arrangement depicted in FIG. 8a and b. The network node 150 is configured to assist the first IMS node 110 in selecting a second IMS node from one or more second IMS nodes 131, 132, 133 in the communications network 100. The second IMS node 131, 132, 133 and the first IMS node 110 are adapted to operate in the IMS network 105. Any one or more out of: The network node 150 may be a 5GC NRF node 150, the one or more second IMS node 131, 132, 133 may be an S-CSCF 131, 132, 133, and the first IMS node 110 may be an I-CSCF 110.

The network node 150 may comprise an input and output interface 800 configured to communicate with e.g. the first IMS node 110, the second IMS node 131, 132, 133 and with network nodes in the communications network 100 and the IMS network 105.

The network node 150 is further configured to, e.g. by means of an obtaining unit 810 in the network node 150, obtain respective data associated to each of one or more second IMS nodes 131, 132, 133. For each second IMS node 131, 132, 133 the associated data is adapted to indicate one or more supported capabilities.

The network node 150 is further configured to, e.g. by means of a receiving unit 820 in the network node 150, receive, from the first IMS node 110, a request to identify one or more second IMS nodes for a registration procedure related to the UE 121. The request is adapted to comprise one or more capabilities associated to a second IMS node to be used in the registration procedure. The identification is adapted to be based on the one or more capabilities.

The one or more capabilities may be adapted to comprise at least one mandatory capability.

The one or more capabilities may further be adapted to indicate any one or more out of: One or more optional capabilities, and one or more mandatory capabilities, The request may be adapted to comprise a preferred locality of the one or more second IMS nodes to be identified.

The network node 150 is further configured to, e.g. by means of a generating unit 830 in the network node 150, generate selection data related to one or more identified second IMS nodes 131, 132, 133. The selection data is adapted to be generated based on the one or more capabilities. The one or more identified second IMS nodes 131, 132, 133 is adapted to support at least one of the one or more capabilities.

The network node 150 may further be configured to, e.g. by means of the generating unit 830 in the network node 150, generate the selection data by further being configured to identify the one or more second IMS nodes 131, 132, 133 based on the one or more capabilities. The identified one or more second IMS nodes 131, 132, 133 are adapted to support at least one of the at least one mandatory capability

The selection data may be adapted to indicate a priority of the one or more identified second network nodes 131, 132, 133.

The network node 150 is further configured to, e.g. by means of a sending unit 840 in the network node 150, send a response to the request to the first IMS node 110. The response is adapted to comprise the selection data related to a selection of a second IMS node from the one or more identified second IMS nodes 131, 132, 133.

The embodiments herein may be implemented through a respective processor or one or more processors, such as the processor 850 of a processing circuitry in the network node 150 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the network node 150. One such carrier may be in the form of a CD ROM disc. It is however feasible with other data carriers such as a memory stick. The computer program code may furthermore be provided as pure program code on a server and downloaded to the network node 150.

The network node 150 may further comprise a memory 860 comprising one or more memory units. The memory 860 comprises instructions executable by the processor 850 in the network node 150. The memory 860 is arranged to be used to store e.g. information, messages, indications, subscriber data, data, profile data, selection data, service requests, connections, identities, communication data and applications and applications to perform the methods herein when being executed in the network node 150.

In some embodiments, a computer program 870 comprises instructions, which when executed by the respective at least one processor 850, cause the at least one processor 850 of the network node 150 to perform the actions above.

In some embodiments, a respective carrier 880 comprises the respective computer program 870, wherein the carrier 880 is one of an electronic signal, an optical signal, an electromagnetic signal, a magnetic signal, an electric signal, a radio signal, a microwave signal, or a computer-readable storage medium.

Those skilled in the art will appreciate that the units in the se network node 150 described above may refer to a combination of analog and digital circuits, and/or one or more processors configured with software and/or firmware, e.g. stored in the network node 150, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### Further Extensions and Variations

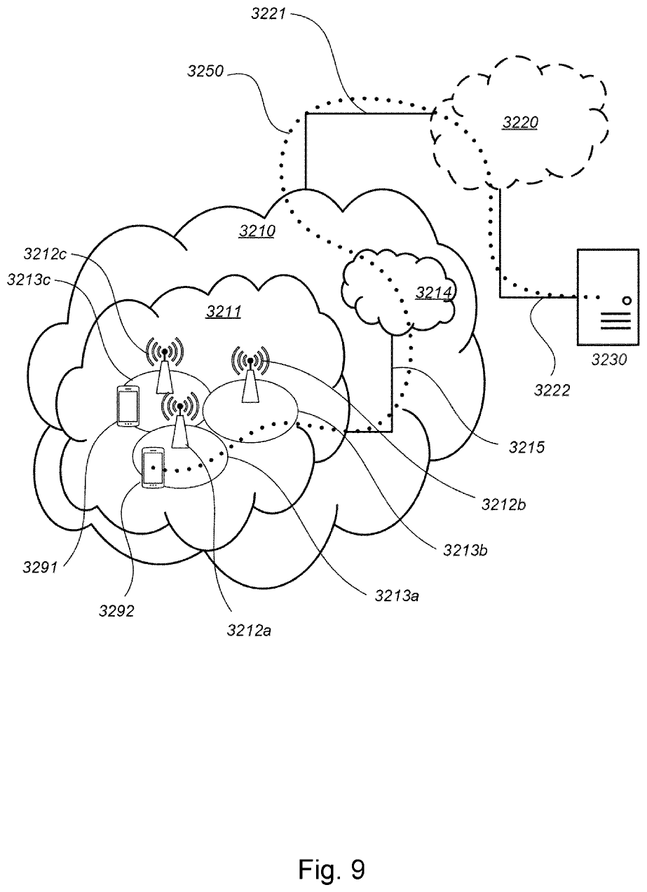

With reference to FIG. 9, in accordance with an embodiment, a communication system includes a telecommunication network 3210, such as a 3GPP-type cellular network, which comprises an access network 3211, such as a radio access network, and a core network 3214. The core network 3214 may e.g. comprise the network node 150, the first IMS node 110, the one or more second IMS nodes 131, 132, 133 and the subscriber data node 140. The access network 3211 comprises a plurality of base stations 3212a, 3212b, 3212c, e.g. the base station 105, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the UE 121 and/or a Non-AP STA 3291 located in coverage area 3213c is configured to wirelessly connect to, or be paged by, the corresponding base station 3212c. A second UE 3292 such as another UE 121 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

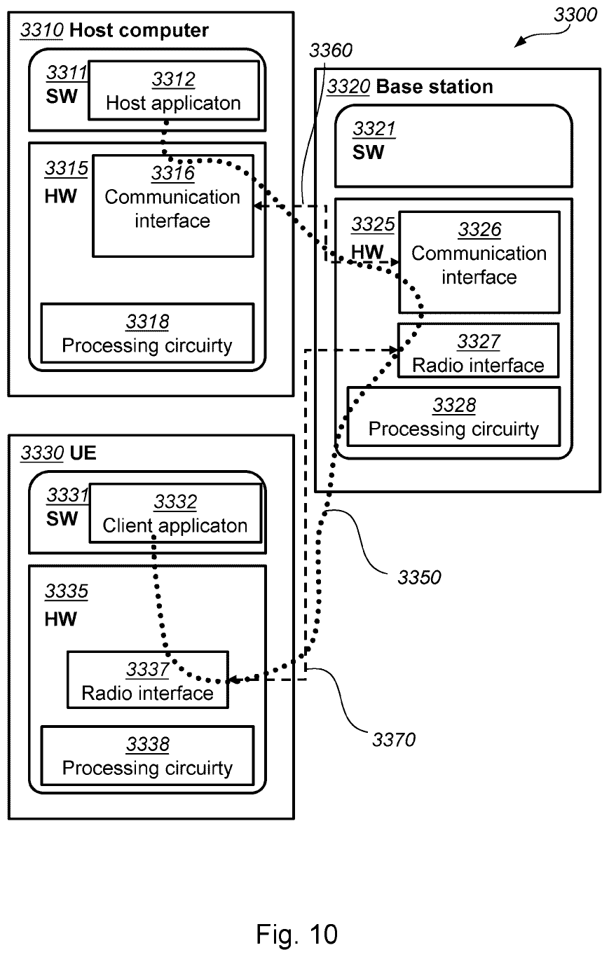

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to setup and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to setup and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

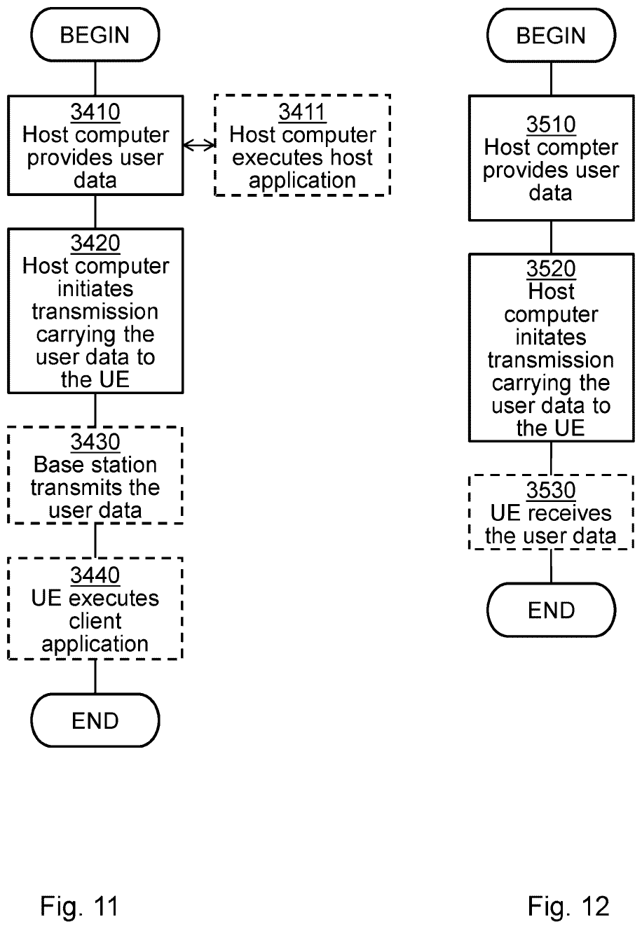

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

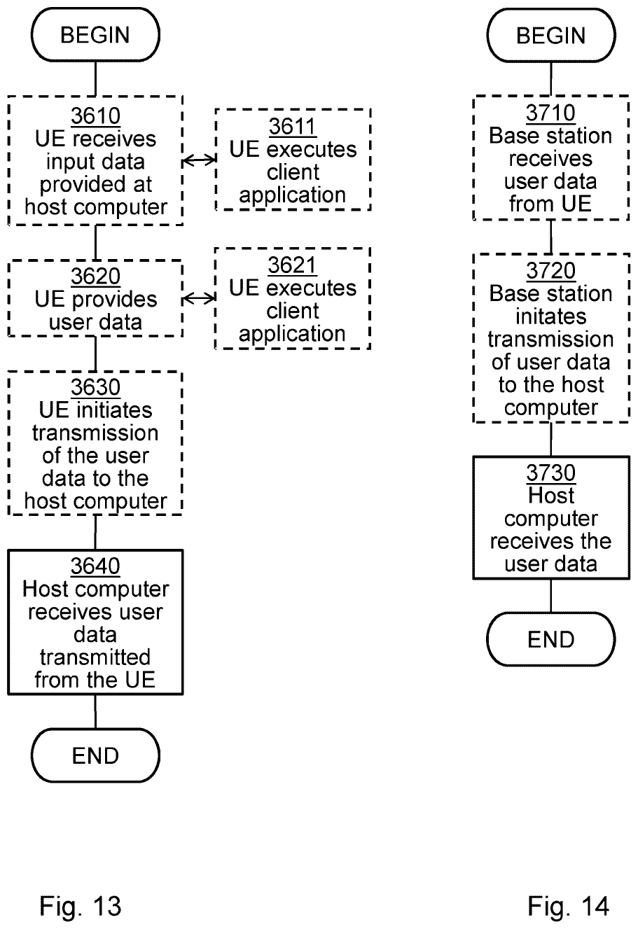

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 13 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a first Internet Protocol, IP, Multimedia Subsystem, IMS, node for selecting a second IMS node from one or more second IMS nodes in a communications network, the first IMS node and the one or more second IMS nodes are operating in an IMS network, the method comprising:
upon receiving, from a User Equipment, UE, a registration request message requesting the UE to be registered to the IMS network, obtaining, from a subscriber data node, subscriber data related to the UE, which subscriber data comprises one or more capabilities associated to a second IMS node to be used in the registration procedure;
sending, to a network node, a request to identify one or more second IMS nodes for the registration procedure, based on the one or more capabilities in the obtained subscriber data, which request comprises the one or more capabilities;
receiving a response to the request from the network node, which response comprises selection data related to a selection of a second IMS node from one or more identified second IMS nodes, which one or more identified second IMS nodes supports at least one of the one or more capabilities comprised in the obtained subscriber data;
selecting a second IMS node from the one or more identified second IMS nodes for registering the UE to the IMS network, which selecting is based on the received selection data; and
proceeding with the registration of the UE by sending a message to the selected second IMS node, which message requests the selected second IMS node to register the UE to the IMS network.

2. The method according to claim 1, wherein the any one or more out of:
the one or more capabilities indicates one or more mandatory capabilities;
the one or more capabilities indicates one or more optional capabilities; and
the request comprises a preferred locality of the one or more second IMS nodes to be identified.

3. The method according to claim 1, wherein the selection data indicates, for each of the identified one or more second IMS nodes, a priority related to selection of a second IMS node.

4. The method according to claim 3, wherein the selection data indicates a priority of the one or more identified second network nodes, and wherein selecting the second IMS node comprises selecting a second IMS node from the one or more identified second IMS nodes with the highest priority according to the selection data.

5. The method according to claim 1, wherein any one or more out of:
the network node is a 5G Core, 5GC, Network Repository Function, NRF, node;
the one or more second IMS node is a Serving Call Session Control Function, S-CSCF; and
the first IMS node is an Interrogating Call Session Control Function, I-CSCF.

6-7. (canceled)

8. A method performed by a second Internet Protocol, IP, Multimedia Subsystem, IMS, node for assisting a first IMS node in selecting a second IMS node from one or more second IMS nodes in a communications network, the second IMS node and the first IMS node are operating in an IMS network, the method comprising:
during a start-up procedure, registering data associated to the second IMS node in a network node, which data indicates one or more supported capabilities associated to the second IMS node;
wherein the registered data assists the first IMS node to identify the second IMS node and perform a selection of a second IMS node to be used for registering a User Equipment, UE, to the IMS network; and
registering the UE by receiving a message from the first IMS node, which message requests the second IMS node to register the UE to the IMS network.

9. The method according to claim 8, wherein the data associated to the second IMS node further comprises a Fully Qualified Domain Name, FQDN, related to the second IMS node.

10. The method according to claim 8, wherein any one or more out of:
the network node is a 5G Core, 5GC, Network Repository Function, NRF, node;
the one or more second IMS node is a Serving Call Session Control Function, S-CSCF; and
the first IMS node is an Interrogating Call Session Control Function, I-CSCF.

11-12. (canceled)

13. A method performed by a network node for assisting a first Internet Protocol, IP, Multimedia Subsystem, IMS, node in selecting a second IMS node from one or more second IMS nodes in a communications network, the second IMS node and the first IMS node are operating in an IMS network, the method comprising:
obtaining respective data associated to each of one or more second IMS nodes, wherein for each second IMS node the associated data indicates one or more supported capabilities;
receiving, from the first IMS node, a request to identify one or more second IMS nodes for a registration procedure related to a UE, the request comprising one or more capabilities associated to a second IMS node to be used in the registration procedure, which identification is based on the one or more capabilities;
generating selection data related to one or more identified second IMS nodes, which selection data is generated based on the one or more capabilities, wherein the one or more identified second IMS nodes supports at least one of the one or more capabilities; and
sending a response to the request to the first IMS node, which response comprises the selection data related to a selection of a second IMS node from the one or more identified second IMS nodes.

14. The method according to claim 13, wherein the one or more capabilities comprises at least one mandatory capability, and wherein the generating further comprises identifying the one or more second IMS nodes based on the one or more capabilities, wherein the identified one or more second IMS nodes supports the at least one of the at least one of the mandatory capability.

15. The method according to claim 13, wherein any one or more out of:
the one or more capabilities indicates one or more mandatory capabilities;
the one or more capabilities further indicates one or more optional capabilities; and
the request comprises a preferred locality of the one or more second IMS nodes to be identified.

16. The method according to claim 13 any of claims, wherein the selection data indicates a priority of the one or more identified second network nodes.

17. The method according to claim 13, wherein any one or more out of:
the network node is a 5G Core, 5GC, Network Repository Function, NRF, node;
the one or more second IMS node is a Serving Call Session Control Function, S-CSCF; and
the first IMS node is an Interrogating Call Session Control Function, I-CSCF.

18-32. (canceled)

33. The method according to claim 2, wherein the selection data indicates, for each of the identified one or more second IMS nodes, a priority related to selection of a second IMS node.

34. The method according to claim 2, wherein any one or more out of:
the network node is a 5G Core, 5GC, Network Repository Function, NRF, node;
the one or more second IMS node is a Serving Call Session Control Function, S-CSCF; and
the first IMS node is an Interrogating Call Session Control Function, I-CSCF.

35. The method according to claim 14, wherein any one or more out of:
the one or more capabilities indicates one or more mandatory capabilities;
the one or more capabilities further indicates one or more optional capabilities; and
the request comprises a preferred locality of the one or more second IMS nodes to be identified.

36. The method according to claim 14, wherein the selection data indicates a priority of the one or more identified second network nodes.

37. The method according to claim 15, wherein the selection data indicates a priority of the one or more identified second network nodes.

38. The method according to claim 19, wherein the selection data indicates a priority of the one or more identified second network nodes.
